(19) United States
(12) Patent Application Publication
(10) Pub. No.: US 2005/0139022 A1
(43) Pub. Date: Jun. 30, 2005

(54) Propulsion apparatus using centrifugal force

(76) Inventor: Masafumi Hoshino, Nagoya-shi (JP)

Correspondence Address: ARENT FOX PLLC, 1050 CONNECTICUT AVENUE, N.W., SUITE 400, WASHINGTON, DC, 20036, US

(21) Appl. No.: 10/752,227

(22) Filed: Jan. 7, 2004

(30) Foreign Application Priority Data
Dec. 25, 2003 (JP) 2003-430592

(51) Int. Cl. F16H 27/04

(52) U.S. Cl. 74/84 S

(57) ABSTRACT

[Problem] It is an object to provide a propulsion apparatus having an improved efficiency and an excellent durability.

[Solution] In a range encompassed by an inner wall having a shape of circle locus which is a predetermined, a rotating body 8 is provided for being rotated compulsory around the same axis as the circle locus. In the rotating body 8, a moving body 12 is provided so as to move in a direction of transverse axis of a rotating center. The moving body 12 has a pair of weights at both ends thereof. A diameter of the circle locus and a reach of the rotating body is set at the ratio of 10 to 9. At a surface of the inner wall, there is a swelling wall 14 as a guide member protruding within the predetermined rotating range around the circumference thereof continuously in a gradual curve. While a weight 11 (11A) rotates along the swelling wall 14, the moving body 12 is returned by centrifugal force. When the moving body 12 passes P3, a positional relationship between the farther weight 11 (11A) and the closer weight 11 (11B) from the center is changed. It should be noted that P3 indicates a point where the diameter of the circle locus and a return distance of the moving body from the swelling wall is set at the ratio of 10 to 0.5.

### TECHNICAL FIELD

The present invention relates to a propulsion apparatus using centrifugal force (hereinafter, simply referred to as a propulsion apparatus), in which centrifugal force operates on a pair of weights provided with a rotating body.

### PRIOR ART

As an example of a propulsion apparatus described above, an apparatus is disclosed in Patent document 1 which is previously proposed by the applicant.

This apparatus utilizes a following principle: a plurality of weights provided with a rotating body is rotated around a locus which is eccentric to a locus around the same axis of the rotating body in order to render centrifugal force biased in one direction, thereby generating propulsion force.

As a rotating locus of the weights, a round locus whose axis is dislocated against the rotating axis, and an incomplete round axis in which a part of a concentric circle with the rotating axis is deformed toward the center of the circle are adopted.

[Patent document 1]
Japanese patent publication of unexamined application No. 2003-3946

### DISCLOSURE OF THE INVENTION

[Problems to be Solved by the Invention]

A conventional apparatus includes a rotating body totally encompassed by a circumferential wall. The wall receives centrifugal force, and introduces weights to a rotation locus along the wall. With this structure, the weights always contact with the inner surface of the wall. Meanwhile, an energy loss could occur due to the contact resistance, and the weights as well as the inner surface of the wall could wear out.

It is desirable that a plurality of weights is disposed evenly, and further, the best balance is to dispose two weights at lateral ends having a rotation axis between them as a minimal structure. In this structure, each weight is pushed on the inner surface of the wall by centrifugal force working on each weight.

Propulsion force is generated by total centrifugal force, which is the difference between the centrifugal force working on each weight. However, each weight contacts the wall in all directions (that is, 360 degrees) and the amount of centrifugal force working on the wall, which works on the inner surface of the wall, is equal to the total amount of centrifugal force working on each weight. As a result, an energy loss could occur, which could be a factor of deteriorating propulsion efficiency.

An object of the present invention is to provide a propulsion apparatus for reducing an energy loss with a reasonable structure. It includes a rotating body provided in a disc-shaped predetermined rotating range so as to be rotated compulsory around an axis disposed at an almost center of the predetermined rotating range. It also includes a moving body provided with the rotating body having a pair of weights disposed at both ends thereof with a rotating center between them so as to move in a direction of transverse axis of a rotating center and both outer ends of the weights, which are farthest from the center of the rotating body, have a mutual distance which is within a diameter of the predetermined rotating range without fail. It also includes a stopper provided at a circumference of the predetermined rotating range or with the rotating body, so that a rotating position of an end of one weight more distant from the center of the rotating body than the other, the end is farthest from the rotating center, is regulated so as to substantially correspond to a circle locus of the predetermined rotating range. It further includes a guide member provided at a part of the rotating locus of the weights in order to attach the weight more distant from the center of the rotating body than the other. The guide member introduces the rotating body by returning the same in the direction of rotating body's center with a distance approximately corresponding to a half or above of the difference between the diameter of the predetermined rotating range and the mutual distance of both outer ends of the weights, the outer ends are farthest from the center of the rotating body. By means of the guide member a positional relationship is alternately changeable between the weight having a long distance from the center of the rotating body and the weight having a short distance from the center of the rotating body.

Moreover, the stopper can be a wall formed along the circumference of the predetermined rotating range. The moving body is incorporated into a penetration route formed in a rotating body in a state that two weights are protruding from the penetration route, and both ends of the penetrating route serve as a stopper by making the size of the weights bigger than that of lateral openings of the penetrating route. On the other hand, the moving body is incorporated into a penetration route formed in a rotating body in a state that two weights are stored in the penetration route, and both ends of the penetrating route serve as a stopper by making the area of lateral openings of the penetrating route smaller than a cross sectional area of each weight.

In addition, the guide member can be an expansion wall sticking out into the predetermined rotating range at the circumference thereof in a continuous and gradual curve.

According to the invention, the weights provided with the rotating body include two outer ends which are farthest from the center of the rotating body. Then, the outer ends have a mutual distance which is within a diameter of the predetermined rotating range without fail. Moreover, by means of the guide member a positional relationship is alternately changeable between the weight having a long distance from the center of the rotating body and the weight having a short distance from the center of the rotating body. Accordingly, an absolute propulsion force toward one direction is generated since a moving force of the rotating body toward a radial direction is set within 180 degrees among 360 degrees unlike a conventional apparatus in which the moving force is set in a direction of 360 degrees, thereby improving propulsion efficiency.

Particularly, when the stopper is a wall formed along a circumference of the predetermined rotating range, the weights do not contact with the wall frequently. In addition, when the stopper is a both lateral ends of the penetrating route, the weights have a minimum contact with the wall.

Particularly, when the guide member is an expansion wall sticking out into the predetermined rotating range at the circumference thereof in a continuous and gradual curve, the shock is reduced in alternately change of positional relationship between the weight having a long distance from the center of the rotating body and the weight having a short distance from the center of the rotating body.

### BEST MODES FOR EMBODYING THE INVENTION

Hereinafter, a propulsion apparatus according to the present invention will be explained based on a model mounted on a dolly.

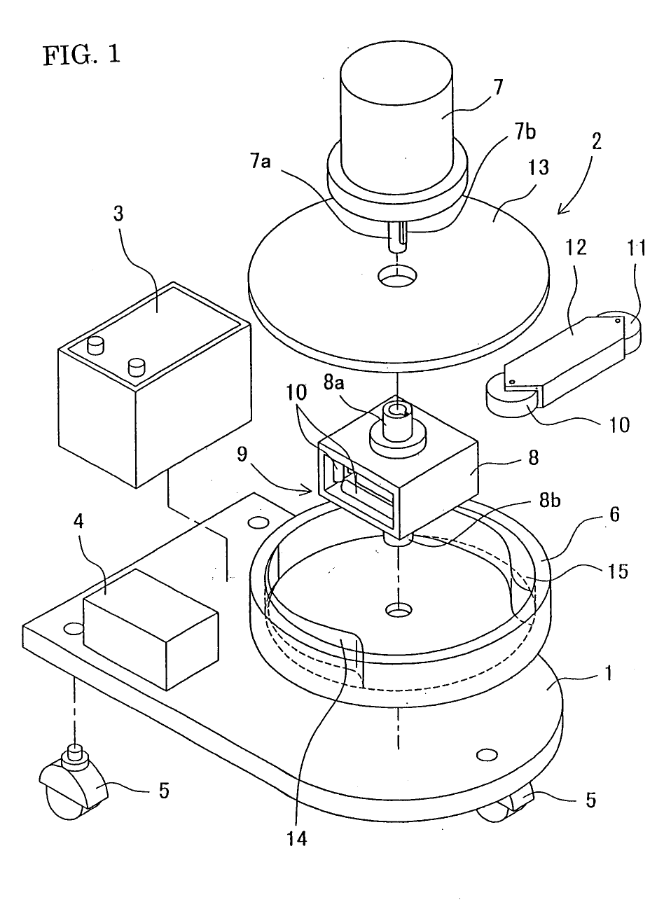

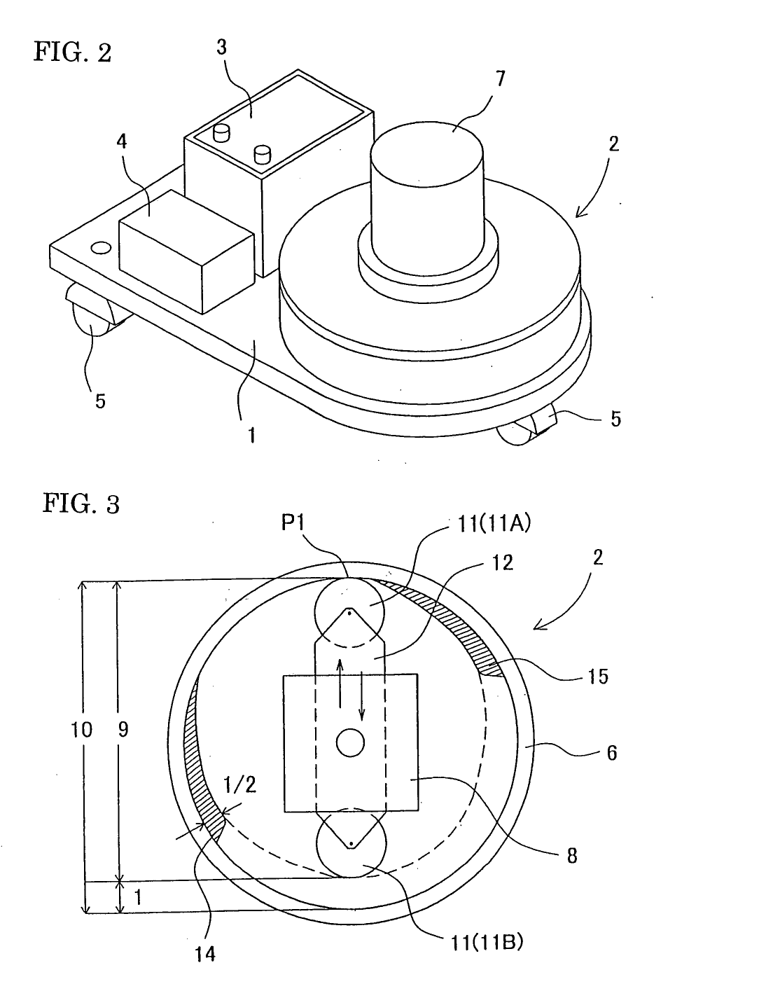

FIG. 1 is an exploded view of the model, and FIG. 2 shows a built-up model. The reference number 1 denotes a dolly, the reference number 2 denotes a propulsion apparatus, the reference number 3 denotes a battery, and the reference number 4 denotes a controller.

The dolly 1 has three casters 5, 5 . . . so as to move freely on flat grounds or slopes. The dolly 1 has an area for mounting the propulsion apparatus 2, the battery 3 and the controller 4 on the top thereof.

The propulsion apparatus 2 has a housing 6 which has a circle locus shape and whose inner circumference is previously set to be a predetermined rotating range. In the housing 6, a rotating body 8 is installed to be compulsory rotated by a motor 7 around the center of the circle locus.

The motor 7 is driven by the battery 3 as a power supply. Moreover, rotating speed of the motor 7 can be controlled by the controller 4.

The rotating body 8 has a rotating axis 8a, 8b at the top and the bottom thereof to penetrate the same. Further, the rotating route 8 has a penetrating route 9 which traverses the middle of the rotating route 8. At the inner surface of the penetrating route 9, there is a plurality of thrust rollers 10, 10 . . . in an array perpendicular to the penetrating direction. Then, a moving body 12 having two weights 11,11 at both longitudinal ends thereof is provided in the penetrating route 9 so as to move freely in the penetrating direction.

It should be noted that 13 in the figure denotes a cover for the housing 6. In both the cover 13 and the housing 6, sockets (not shown) for receiving the rotating axis 8a, 8b of the rotating body 8 are provided. In addition, a key 7b connects the rotating axis 7a of the motor 7 with the rotating axis 8a of the rotating body 8.

Next, the structure of the complete propulsion apparatus 2 will be explained based on FIG. 3. The weights 11, 11 . . . are small enough not to engage with both lateral openings of the penetrating route 9. Accordingly, a moving body 12 can move from one side to the other side in the penetrating route 9 rarely being suffered from the resistance of the thrust rollers 10, 10.

Both lateral ends of the moving body 12 has a symmetrical structure and well-balanced in view of the weight. Moreover, a mutual distance of both outer ends of the weights which are farthest from the center of the rotating body (hereinafter, referred to as a reach) is within a diameter of the rotating locus of the predetermined rotating range.

In this embodiment, a diameter of the rotating locus and a reach of the moving body is set at the ratio of 10 to 9, and a diameter of the rotating locus and a moving distance of the moving body is set at the ratio of 10 to 1.

On the other hand, the inner wall of the housing 6 is used as a stopper to receive the weight 11 (11A) which is positioned at the outer side of the moving body 12 and attempting to project in a radiation direction by centrifugal force, and to guide the weight along the circle locus of the predetermined rotating range. Further, at a part of the inner wall of the housing 6, there is a swelling wall 14 serves as a guide member which guides the moving body by returning the same in the direction of the center with a distance approximately corresponding to a half or above of the difference between the radius of the predetermined rotating range and the reach of the moving body. The swelling wall 14 protrudes within the predetermined rotating range around the circumference thereof continuously in a gradual curve.

On the other hand, in an opposing surface of the inner wall where the swelling wall 14 is provided, a swelling wall 15 symmetrical to the swelling wall 14 is provided as a sub guide member. The swelling wall 15 controls the weight 11 which attempts to project by centrifugal force, in order to guide the weight along the circle locus of the predetermined rotating range.

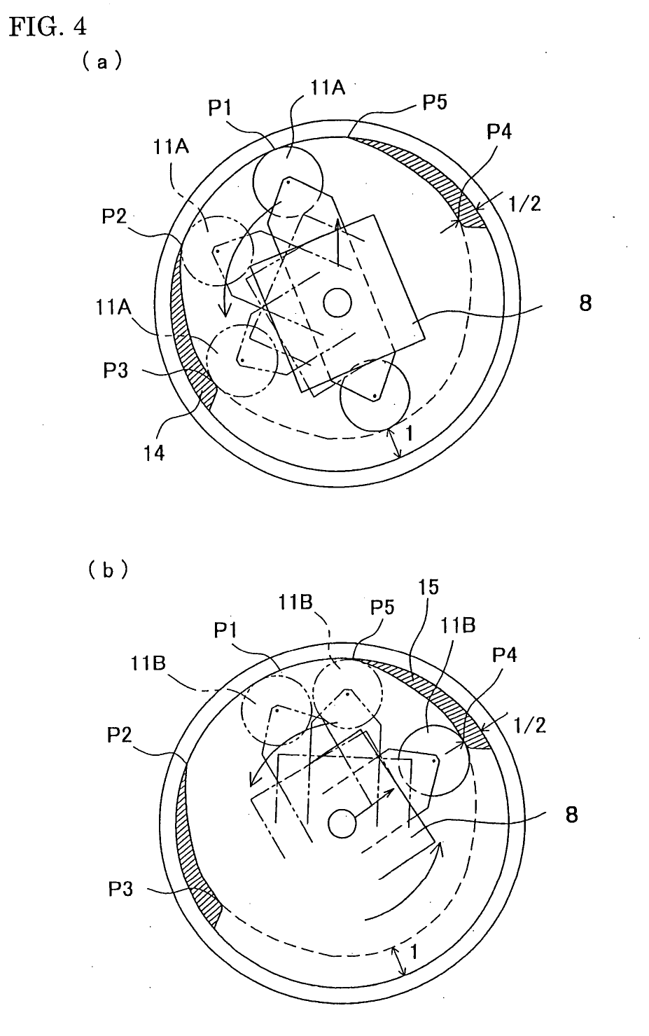

The operation of the propulsion apparatus having the above structure will be explained referring to FIG. 4. When the moving body 12 shifts toward one of the weights 11, 11 (here, a weight 11A) to contact P1 of the circle locus and then rotates in a counterclockwise direction, the weight 11A rotates while being pushed on a wall with centrifugal force applied on the weight 11A.

When the moving body 12 comes near P2 which is one end of the swelling wall 14, the weight 11A is returned toward the center by means of the guide surface of the swelling wall 14.

When the moving body 12 passes P3, it shifts toward the other weight 11 (here, a weight 11B) across the rotating center, and thus the weight 11B attempts to project in a radiation direction. Here, P3 indicates a point where the swelling wall 14 protrudes inward by one-twentieth of the diameter of circle locus of the predetermined rotating range, that is, the diameter of the circle locus and the distance of the outer end of the weight 11A from the wall is set at the ratio of 10 to 0.5.

In this case, the centrifugal force applied to the weight 11B is received at P4 on a swelling wall 15. By means of a guide surface of the swelling wall 15, the weight 11B is rotated and moved along the wall, passing P5 which is the end of the swelling wall 15, toward P1.

According to the above, while the rotating body 8 makes a turn a pair of weights 11A, 11B of the rotating body 12 alternately passes contacting to a rotating locus from P4 to P3. Meanwhile, the intensive centrifugal force applies on the above locus, thereby generating propulsion force in the direction of the above locus.

On the other hand, the weights do not contact with the wall surface to which no intensive centrifugal force is applied. Further, a wall surface to which the intensive centrifugal force is applied receives only force corresponding to propulsion force because of the reaction of centrifugal force applied on a weight positioned at the opposite side.

Therefore, a contact resistance is reduced, thereby decreasing an energy loss.

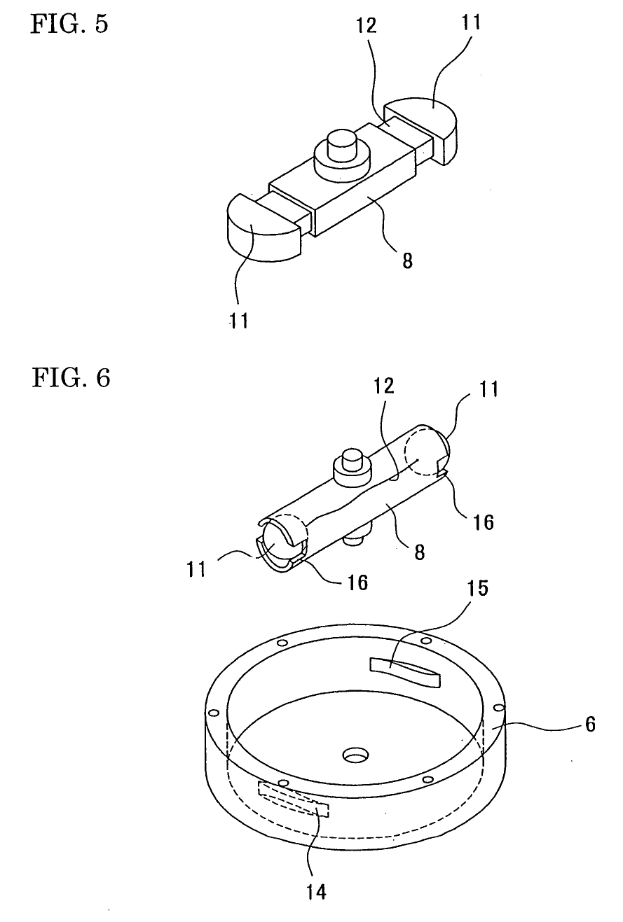

In the above embodiment, the inner wall is utilized as a stopper to control the projecting direction of the weight against the moving body which is movable through the penetrating route. On the other hand, as shown in FIG. 5, the lateral sides of the penetrating route can be used as a stopper in which the weights 11, 11 may be larger than a lateral opening spaces of the penetrating route, so that the weights can not pass through the openings by being engaged with the same.

By doing this, a large propulsion force is obtained because of the large size of the weight. In addition, the moving body is not detached from the rotating body even when the propulsion apparatus is separated into pieces. As a result, it is prevented that the moving body has disappeared in a repair or maintenance.

The swelling wall needs not to extend from the top to the bottom of the wall. As shown in FIG. 6, rib-shaped swelling walls 14, 15 can be provided only at the center portions to which the weights contact if the weights 11 are balls. In this case, if the rotating means is a weight-housing type, a slit 16 is provided at the lateral openings of the rotating body 8 in order to evade the interference from the swelling walls 14, 15.

In this embodiment, the moving body 12 consists of a string and distance between the weights are changeable. However, it is the same as the prior embodiment in that a reach of the weights which are most separated is within a diameter of the circle locus of the predetermined rotating range.

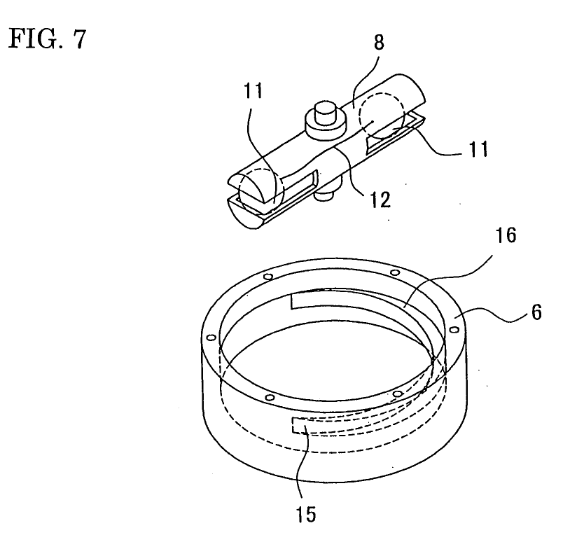

FIG. 7 shows the rotating body 8 which completely contains the weights. The lateral ends of the penetrating route are utilized as stoppers because their dimensions are smaller than the cross sectional dimension of each weight.

Similar to the prior embodiment, in this embodiment the swelling walls 14, 15 can be provided only at the portions to which the weights contact. Further, as shown in FIG. 7 the swelling walls 14, 15 can be integrated by being provided in a series.

Besides the above embodiments, the other embodiments can be achieved although they are not shown in the drawings. For example, the rotating body has a long hall formed in the moving direction of a moving body, and the moving body has a pin for penetrating the hall. With this structure, the moving body is provided with the rotating body with a play in the moving direction, and both lateral ends of the long hall is utilized as a stopper.

On the other hand, it is possible to provide a twin-type rotating body, in which a pair of moving body is provided in parallel. When a positional relationship changes between the weight having a long distance from the center and the weight having a short distance from the center, one weight moves slightly behind the other and follows the same successively. Therefore, the shock is reduced and even if one weight does not move in order the other weight can be a relief, whereby at least half propulsion force can be maintained.

Moreover, another embodiment having a structure of the pin and the long hall contrary to the prior embodiment may be achieved. Here, both lateral ends of the long hall provided with the moving body are used as a stopper. Then, two kinds of structure are conceived: a stopper between the rotating body and the moving body, and a stopper between the moving body and the weights.

The first structure of the stopper between the rotating body and the moving body is as follows. First, a pin is provided at the rotating center of the rotating body, and a long hall is formed in the moving body. Then the pin penetrates the long hall with a play and the lateral ends of the hall are used as a stopper. By doing this, centrifugal force is applied to the pin of the rotating center, so that the weights are prevented from contacting any other parts except to the swelling wall, the inner surface of the housing, for example.

The second structure of the stopper between the moving body and the weights is similar to the first structure, and the stopper function is realized by means of the pin and the long hall. In a switch of the farthest weight, the swelling wall has only to return the weight without returning the whole moving body, which reduces a burden for the swelling wall.

It should be noted that the swelling wall is divided into the upper wall and the lower wall when weights are separated accordingly.

The moving body may consist of a string of several weights. By doing this, a fine adjustment of weight balance can be realized because several weights having different gravity are combined.

Accordingly, special effect such as engine vibration is feasible when weight balance is uneven so as to dislocate a moving point of the moving body, or dimensional error of the guide member can be adjusted at the moving body's side.

In addition, the structure in which a spring installed in the moving body has an impetus toward the weights in the operating direction of centrifugal force can be achieved. By doing this, the weights can be retracted toward the moving body when an excessive load is applied to the weights to absorb the load, whereby damage can be prevented.

It should be noted that the propulsion structure is not limited in a single use, but a plurality of structures may be used in a unit. For example, arrangement in alignment or at random on the same plane, or superimposing one another, or combination of the above. With this plural use, stability of propulsion force is improved. 4

Further, not only a horizontal arrangement, but an inclined or perpendicular arrangement may be acceptable. For example, a rotating motor distributes its driving force into two directions contrary to each other by using a gear, and transmits the force to each propulsion structure.

Further, each moving means may be used as a guide member in an arrangement in which a pair of propulsion structures are disposed adjacent to each other. An example will be explained as follows. A gourd-shaped housing is formed in which two circle locus are combined so as to overlap to each other. Then, the overlap length is set to correspond to a half of the difference between the diameter of the circle locus and a reach of the moving body. At the overlapped portion, two moving bodies push the other repeatedly, resulting that a positional relationship between the weight having a long distance from the center and the weight having a short distance from the center is changed.

It should be noted that a reverse rotation is smoothly conducted when the guide member continuously extends till the sub guide member. On the contrary, it is possible to omit the sub guide member and to provide the guide member in a minimum range in order to achieve the propulsion structure with a light weight.

As described above, the propulsion apparatus according to the present invention has a high propulsion efficiency because of reduction of contact resistance. It also has prominent durability and excellent reliability.

The propulsion apparatus of the present invention can be desirably utilized for not only a moving object on the ground but a flying object in the air.

### BRIEF DESCRIPTION OF THE DRAWINGS

[FIG. 1] FIG. 1 is an exploded view of a model on a dolly mounting a propulsion apparatus according to the present invention.

[FIG. 2] FIG. 2 shows a built-up model on a dolly mounting the propulsion apparatus according to the present invention.

[FIG. 3] FIG. 3 shows a structure of the propulsion apparatus.

[FIG. 4] FIG. 4 shows the operation of the propulsion apparatus.

[FIG. 5] FIG. 5 shows a modification of a moving body.

[FIG. 6] FIG. 6 shows a modification of the moving body.

[FIG. 7] FIG. 7 shows a modification of the moving body.

### EXPLANATION OF REFERENCE NUMBERS

1 . . . dolly, 2 . . . propulsion apparatus, 3 . . . battery, 4 . . . controller, 5 . . . caster, 6 . . . housing, 7 . . . motor, 7a . . . rotating axis, 7b . . . key, 8 . . . rotating body, 8a, 8b . . . rotating axis, 9 . . . penetrating route, 10 . . . thrust roller, 11(11A, 11B) . . . weight, 12 . . . moving body, 13 . . . cover, 14 . . . swelling wall (a guide member), 15 . . . swelling wall (a sub guide member), 16 . . . slit

1. A propulsion apparatus using centrifugal force comprising:
a rotating body provided in a disc-shaped predetermined rotating range for being rotated compulsory around an axis disposed at the almost center of the predetermined rotating range;
a moving body provided with the rotating body so as to move in a direction of transverse axis of a rotating center and having a pair of weights disposed at both ends thereof with the rotating canter between them, and both outer ends of the weights, which are farthest from the center of the rotating body, have a mutual distance which is within a diameter of the predetermined rotating range or the rotating body;
a stopper provided at a circumference of the predetermined rotating range or the rotating body so that a rotating position of an end of one weight farther distant from the center of the rotating body than the other, the end is farthest from the rotating center, is regulated so as to substantially correspond to a circle locus of the predetermined rotating range, and
a guide member provided at a part of the rotating locus of the weights in order to attach the weight farther distant from the center of the rotating body than the other, the guide member introduces the rotating body by returning the same in the direction of rotating body's center with a distance approximately corresponding to a half or above of the difference between the diameter of the predetermined rotating range and the mutual distance of both outer ends of the weights which are farthest from the center of the rotating body,
wherein by means of the guide member a positional relationship is alternately changeable between the weight having a long distance from the center of the rotating body and the weight having a short distance from the center of the rotating body.

2. A propulsion apparatus according to claim 1, wherein the stopper is a wall formed along the circumference of the predetermined rotating range.

3. A propulsion apparatus according to claim 1, wherein the moving body is incorporated into a penetration route formed in a rotating body in a state that two weights are protruding from the penetration route, and both ends of the penetrating route serve as a stopper by making the size of the weights bigger than that of lateral openings of the penetrating route.

4. A propulsion apparatus according to claim 1, wherein the moving body is incorporated into a penetration route formed in a rotating body in a state that two weights are stored in the penetration route, and both ends of the penetrating route serve as a stopper by making the area of lateral openings of the penetrating route smaller than a cross sectional area of each weight.

5. A propulsion apparatus according to any of the claim 1, wherein the guide member is an expansion wall sticking out into the predetermined rotating range at the circumference thereof in a continuous and gradual curve.
